(19) United States
(12) Patent Application Publication
(10) Pub. No.: US 2008/0195410 A1
(43) Pub. Date: Aug. 14, 2008

(54) Service provider selection system and method

(76) Inventor: Pascal Stolz, Kirkland, WA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/069,737

(22) Filed: Feb. 12, 2008

Related U.S. Application Data
(60) Provisional application No. 60/889,493, filed on Feb. 12, 2007.

(51) Int. Cl. G06Q 99/00

(52) U.S. Cl. 705/1

(57) ABSTRACT

Computer-based systems and methods for assisting buyers of goods and/or services. Different categories of information relating to a seller of goods and/or services are predefined and presented to a user as a visual representation of the seller in the form of a polygonal (e.g., hexagonal) diagram. The triangular area extending from each side of the hexagon to the center of the hexagon represents a defined category of information relating to a seller of goods and or services, with each triangular area being sub-divided to represent sub-categories of information. The triangular areas and sub-divided areas can include visual indicators indicating a ranking of the seller in an associated category or sub-category. In another aspect, the system is adapted to provide a buyer with an aggregate visual representation of a seller's performance in relation to a buyer's preferences. In a further aspect, a buyer is provided with the ability to select a particular seller from among a plurality of sellers represented in an aggregate seller representation. An interactive user interface facilitates information retrieval and multi-level browsing.

### RELATED APPLICATION

This patent application claims the benefit of U.S. Provisional Patent Application No. 60/889,493, filed on Feb. 12, 2007, which is incorporated by reference herein in its entirety.

### TECHNICAL FIELD

This invention relates generally to systems and methods for presenting information to a buyer of goods and/or services relating to one or more sellers of goods and/or service. More particularly, the present invention relates to systems and methods of determining and presenting to a buyer a plurality of relevant characteristics relating to a seller.

### BACKGROUND OF THE INVENTION

Generally, a prospective buyer seeking to purchase goods and/or services from another is presented with a choice of what seller to purchase from. In most transactions, a buyer seeks out a seller through commonly known mediums such as, for example: phone books, advertisements, trade journals, industry publications, or the Internet. In the majority of situations a prospective buyer is only provided with information provided by the seller, and therefore the buyer has limited access to impartial information about that seller. In the alternative, prospective buyers may seek out impartial information such as editorial publications, ratings, and reviews. However, such information is often limited, for example: comparisons may be lacking information relevant to a wise decision, information may be difficult to grasp, and comparisons may be difficult to make between sellers,

The rise of the use of computers in recent decades has infiltrated every aspect of life, in particular the way people do business. Businesses of all kinds increasingly rely on the efficiency and accuracy of modern digital systems designed to store, analyze, and communicate every type of data. Due to the specialized nature of implementing and managing such systems, many businesses provide such services. These businesses are commonly referred to as Information Technology (IT) service providers. The success or failure of a particular business may depend at least in part on whether the business was able to make a wise choice regarding which IT service provider.

Typically, selecting a service provider is difficult. The buyer has very few impartial tools with which to evaluate IT service providers. Significant consequences can result if an ill-fit provider is selected, including, for example: product delays, customer loss, and increased cost.

Some systems that assist buyers to select a seller are known in the art. In one example, systems and publications exist that analyze and score sellers by category. In another example, systems exist that accept input criteria from a prospective buyer and use those criteria to match profiles of sellers. This example further reports scores to a buyer in a 2-d graph having a plurality of commonly intersecting axes, where each axis corresponds to a category.

Known solutions adapted to assist buyers of services, however, are inadequate in that they provide both a less than accurate analysis of service providers' characteristics, or inadequately represent that information to buyers. Therefore, a need exists to provide an improved analysis and representation of one or more service providers to assist prospective buyers.

### SUMMARY OF THE INVENTION

One aspect of the invention is directed to a computer-based system for assisting buyers of goods and/or services. In various embodiments, the system provides defined categories of information relating to a seller of goods and/or services. In some embodiments, the information is automatically gathered information. In other embodiments, the information is manually entered information.

The system provides for analysis of the information, and presentation to the user of a seller specific visual representation of the seller. In one embodiment, the visual representation is a polygonal (e.g., hexagonal) diagram. According to this embodiment, the triangular area extending from each side of the hexagon to the center of the hexagon represents a defined category of information relating to a seller of goods and or services.

In a further embodiment, each triangular area is sub-divided into sub-categories of information. In various embodiments, the triangular areas and sub-divided areas include visual indicators indicating a ranking of the seller in an associated category or sub-category. In various embodiments, these categories and sub-categories are user selectable and selection by the buyer presents additional information regarding the values represented in the sub-category.

In another embodiment, the system is adapted to provide a buyer preference visual representation to the user. The visual representation is adapted to allow the buyer to select a level of importance for each category or sub-category.

In another embodiment, the system is adapted to provide a buyer with an aggregate seller visual representation. In various embodiments, the aggregate seller visual representation provides a graphical representation of how well a plurality of seller's information matches up to a buyer's preferences. In an embodiment, the buyer's preferences are determined using information entered by the buyer using the buyer preference visual representation.

In a further embodiment, a buyer is provided with the ability to select a particular seller from among the sellers represented in the aggregate seller representation. In an embodiment, selection of a seller provides a buyer with the seller specific visual representation for the selected seller. In a further embodiment, the system is adapted to provide an overlay representation of a buyer's preference visual representation and a seller specific visual representation.

Another aspect of the invention is directed to a computer-based method for assisting buyers of goods and/or services. In various embodiments, the method includes providing defined categories of information relating to a seller of goods and/or services. In some embodiments, the method includes automatically gathering information. In other embodiments, the method includes manually entering information. In various embodiments, the method includes analyzing information, and presenting the information to a buyer in the form of a seller specific visual representation. In one embodiment, the seller specific visual representation are presented it as a polygonal (e.g., hexagonal) diagram. According to this embodiment, the method includes dividing the hexagonal diagram into triangular areas extending from each side of the hexagon to the center of the hexagonal. Each triangular area represents a defined category of information relating to a seller of goods and or services.

In a further embodiment, the method includes sub-dividing each triangular area into sub-categories of information. The triangular areas and sub-divided areas may include visual indicators indicating a ranking of the seller in the associated category or sub-category. In various embodiments, the method includes providing to a buyer the ability to select a particular category or sub-category to acquire additional information regarding the values represented therein.

In another embodiment, the method includes providing a buyer preference visual representation to the user. The method further includes providing the buyer with the ability to select a level of importance for each category or sub-category.

In another embodiment, the method includes providing a buyer with an aggregate seller visual representation. In various embodiments, the aggregate seller visual representation is a graphical representation of how well a seller's information matches up to a buyer's preference. In a further embodiment, the method includes providing a buyer with the ability to select a particular seller from among the sellers represented in the aggregate seller representation. In an embodiment, selecting a seller provides a buyer with a seller specific visual representation. In a further embodiment, the method includes providing an overlay representation of the buyer preference visual representation and the seller specific visual representation.

In one aspect of the invention, a technology vendor is evaluated and scored against a series of six objective standardized dimensions D(x) including:
a. A standardized measure of a vendor's financial strength;
b. A standardized measure of a vendor's qualifications;
c. A standardized measure of a vendor's technology portfolio;
d. A standardized measure of a vendor's ability to execute;
e. A standardized measure of a vendor's market positioning; and
f. A standardized measure of a vendor's success ratio.

In a related aspect, each of the standardized dimensions are divided into discrete subset values. In one embodiment, results of the scoring and evaluation are displayed within an polygon such as a hexagon. The scoring and evaluation can be represented by the coverage of the surface area corresponding to the percentage or degree of the score or evaluation achieved, or by indication using a certain mark along an axis from the center of the polygon to any point on the tangent of the side of the polygon corresponding to the vector relating to the objective measures defined above.

In another related aspect, the results of the scoring and evaluation is used to influence a decision or initiate a process. The method can be used to provide a scorecard to provide a composite result expressed in the form of a rating such as a Blue, Bronze, Silver, Gold or Platinum. The rating shown as a digital stamp which cannot be duplicated or faked.

Another aspect of the invention is directed to enabling the customer to more easily identify the scoring and evaluation measures of a plurality of vendors in relationship to each other. One such embodiment allows for real time interactive representation of a plurality of vendors in relationship to each other as a function of D(x) and/or any discrete subset values for a defined solution inquiry request as selected by a customer. The customer can set the desired minimum value for D(x) and/or any discrete subset values directly on the polygon display. Once a buyer has selected a vendor the D(x) values are plotted within the polygon as a function of their score results against the parameters set by the customer. In a related embodiment, the plotting of a given vendor is measured as a function of that vendor's total score with the highest score representing the plotting area such that a better score tends to appear closer to the center of the polygon.

In one embodiment, the user interface provides mouse-over and interactive pop-up displays such that the vendor plot can be hovered over to reveal the customer's name and vital information such as representation of the vendor's hexagon coverage and results. Similarly, the vendor plot can be clicked on to provide a deeper profile of the vendor. In a related embodiment, the customer is given the ability to further drill down into the subset values of selected D(x) categories. The method of claim 12 and 13 where the buyer can further drill down on the vendor hexagon results by clicking on each D(x) or subset values of D(x) and obtain a subset for each element again overlaid on the buyer's subset.

Another aspect of the invention is directed to providing the customer with facilities to more easily identify the scoring and evaluation measures that are most relevant to that customer's requirements. In one embodiment, the customer is provided a system for selecting two measures from D(x) and/or any subset values of D(x), and a minimum to a maximum score threshold for vendors to be considered. The qualified vendors are presented along a two-dimensional space XY such that the distance from the center of the XY axes to the point value (X,Y) of D(x) or of the subset values of D(x) that is the furthest away from the center the lower the score. In a related embodiment, the customer can select multiple pairs of measures from either D(x) and subset values of D(x) to be rendered concurrently.

Another aspect of the invention is directed to a system and method in which a customer can add select one or more of the identified vendors and add them to a list or shopping cart which list will be used to automatically distribute through the computer system a RFI, RFP or RFQ to the selected vendors. Optionally, the system and method includes dynamically pricing the value of the customer lead sent to the vendor either as is or in the form described above.

Optionally, the methods and systems embodying aspects of the invention can be performed or operated by an independent and recognized trusted third party, who would bolster the credibility of the system for enhancing trust in transactions between a plurality of transactional parties, for instance, a customer and vendor(s) of goods and/or services.

### BRIEF DESCRIPTION OF THE DRAWINGS

The invention may be more completely understood in consideration of the following detailed description of various embodiments of the invention in connection with the accompanying drawings, in which:

FIG. 1 illustrates generally one embodiment of a seller specific visual representation according to the subject matter disclosed herein.

FIG. 2 illustrates generally one embodiment of a seller specific visual representation according to the subject matter disclosed herein.

FIG. 3A and FIG. 3B illustrate generally non-conforming shapes.

FIG. 4 illustrates generally one embodiment of a seller specific visual representation according to the subject matter disclosed herein wherein categories are divided into sub-categories.

FIG. 5 illustrates generally an alternative embodiment of the seller specific visual representation.

FIG. 6 illustrates generally one embodiment of drilling down into a seller specific visual representation.

FIG. 7 illustrates generally one embodiment of a buyer preference visual representation.

FIG. 8 illustrates generally one embodiment of aggregate seller visual representation.

FIG. 9 illustrates generally one embodiment wherein a buyer is able to interact with the aggregate seller visual representation.

FIG. 10 illustrates generally the individual seller visual representation provided as an overlay on the buyer's hexagon.

FIG. 11 illustrates generally embodiment wherein the individual seller visual representation of FIG. 10 drilled down.

FIG. 12 illustrates generally one embodiment wherein buyer is provided with a two-category diagram.

FIG. 13 illustrates generally an example of a computer network on which the present invention can be implemented.

FIG. 14 illustrates generally an example of a client-server network on which the invention can be implemented.

FIG. 15 illustrates generally an example of a computer system on which the present invention can be implemented.

The invention may be embodied in other specific forms without departing from the essential attributes thereof; therefore, the illustrated embodiments should be considered in all respects as illustrative and not restrictive.

### DETAILED DESCRIPTION OF THE PREFERRED EMBODIMENTS

Aspects of the invention are directed to providing a number of useful features which benefit to prospective buyers, including:
a simple and easily understandable visual cue that gives an assessment snap shot of a specific seller;
an ability to establish customer specific values to be compared with seller characteristics;
a visual representation of seller characteristics;
interactive capabilities allowing the buyer to manipulate the visual representation to better understand each of the values

In a traditional buyer to seller transaction, a potential buyer initiates a purchasing process by attempting to identify a provider or seller that might be able to meet the customer's requirements. A majority of searches for IT services are initiated in this manner. Often, identification of a suitable IT seller through generic search is a daunting task. Current technologies only provide a link to a potential site of a potential seller without giving any specific assessment of a seller or it's capabilities with respect to a particular project. As a result, these searches rarely lead to identification of an advantageous solution, because they do not respond to a customer specific problem, and do not map the problem or the IT services to their current IT environment. The customer often resorts to making multiple inquiries against a plurality of sellers without any clear understanding of the seller's ability to either meet the customer's requirements; or without an understanding of the seller's solvency.

In various embodiments, the subject matter disclosed herein includes a system and method of representing the evaluation and scoring of an IT services provider through a set of standardized categories. Each of the standardize categories is associated with a standardized measure. In one embodiments, the set of standardized categories includes:
D1—A standardized measure of a seller's financial stability (FS)
D2—A standardized measure of a seller's qualifications (VQ)
D3—A standardized measure of a seller's technology portfolio/products (TP)
D4—A standardized measure of a seller's ability to execute (AE)
D5—A standardized measure of a seller's market positioning (MP)
D6—A standardized measure of a seller's success ratio (SR)

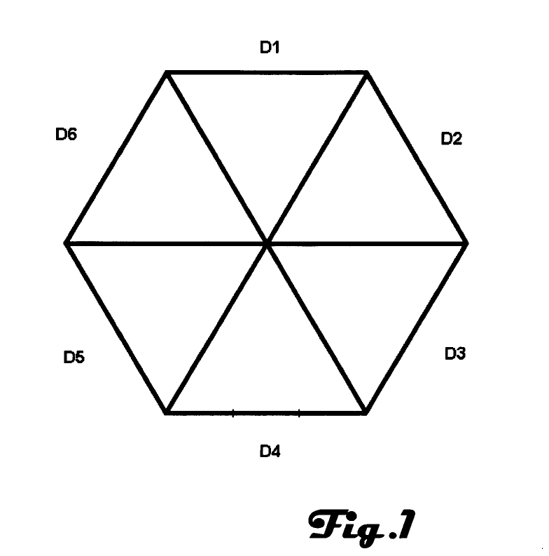

FIG. 1 illustrates generally one embodiment of a seller specific visual representation according to the subject matter disclosed herein. According to the embodiment of FIG. 1, the seller specific visual representation is in the form of a hexagon. In various embodiments, each of the sides of the hexagon corresponds to one of the set of standardized categories (D1-D6 of FIG. 1). Accordingly, the hexagon is divided into 6 slices. Each slice corresponds to one of the standardized categories.

In various embodiments, each of the standardized categories is compiled from an aggregate of values from sub-categories that qualify each standardized category. In various embodiments, the sub-category values may include:
D1—Financial Stability
(a) Customer base
(b) Financial Ratios
(c) R&D Investments
D2—Seller Qualification
(a) Management Team
(b) Technical Team
(c) Support Desk
D3—Technology Portfolio and Products
(a) Product Depth
(b) Product description and UVP
(c) Updates, Upgrades and Patches
D4—Ability to Execute
(a) Engineering and Quality Processes
(b) Chance of successful implementation
(c) Distribution network, resources, capabilities to deliver
D5—Market Positioning
(a) Experience in industry sectors
(b) Reference, Awards, Competitive recognition
(c) Clearly articulated competitive advantage
D5—Success Ratio
(a) Can point to clear measurable results
(b) Number & quality of reference clients—% complaints
(c) On-time/on-budget project completion

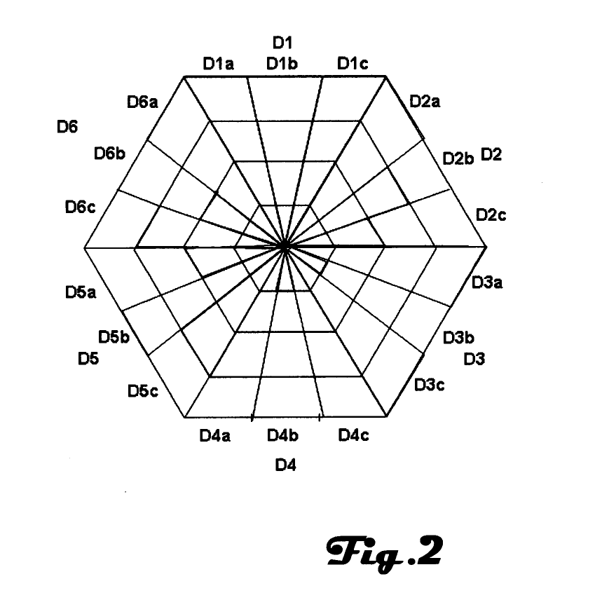

FIG. 2 illustrates generally one embodiment of an seller specific visual representation according to the subject matter disclosed herein. According to this embodiment, each slice corresponding to a standardized category as discussed in FIG. 1 is further divided into three sections. These sections each correspond to sub-categories associated with the standardized category.

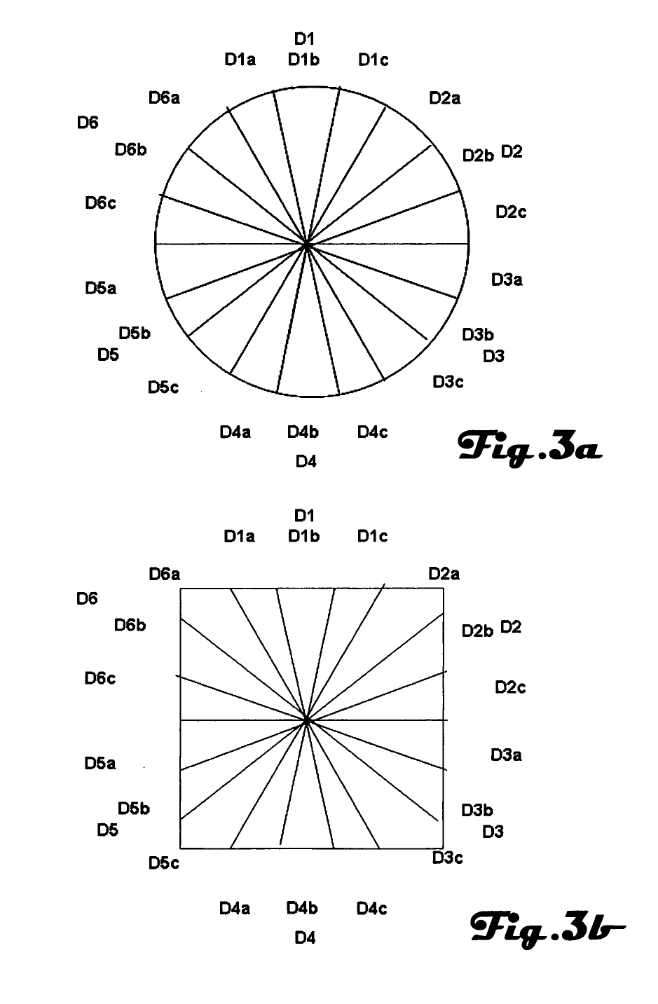

The relevance of a hexagon is further demonstrated when one looks at other standardized non-complex shapes such as a circle or a square/rectangle, as represented in FIG. 3A-FIG. 3B. If we were to apply a series of sub-measurements to a standardized non-complex shape, the ease of readability is lost.

In one embodiment, the range of values associated with the standardized categories and sub-categories range from “failure to meet the minimum of the benchmark” to “maximum score that can be achieved against the benchmark.”

In various embodiments, the determination of values associated with the standardized categories and the sub-categories is achieved through manual analysis or entry of information. In other various embodiments, the determination of values associated with the standardized categories and the sub-categories is achieved through automatic acquisition and/or analysis of information. In still other various embodiments, the determination of values associated with the standardized categories and the sub-categories is achieved through a combination of manual and automatic acquisition and/or analysis of information.

In one embodiment, automatic determination of values is accomplished by defining a series of conditions for comparison. According to these embodiments, information relating to these criteria is acquired though pulling relevant data from specified sources (for example: company records, public records, information provided or supplied by the seller, information purchased through third party sources, web page mining techniques, etc.). According to these embodiments, a score for a particular standardized category or sub-category is determined by automatically comparing of one or more thresholds to one or more values acquire through the pulling of relevant data from specified sources.

In various other embodiments, manual determination of values is accomplished through input, by an evaluator values determined by the evaluator. According to this embodiment, evaluator provided values are accessible to the system such that the system is able to interpret those results and convert them accordingly to establish the value associated with a standardized category or a sub-category.

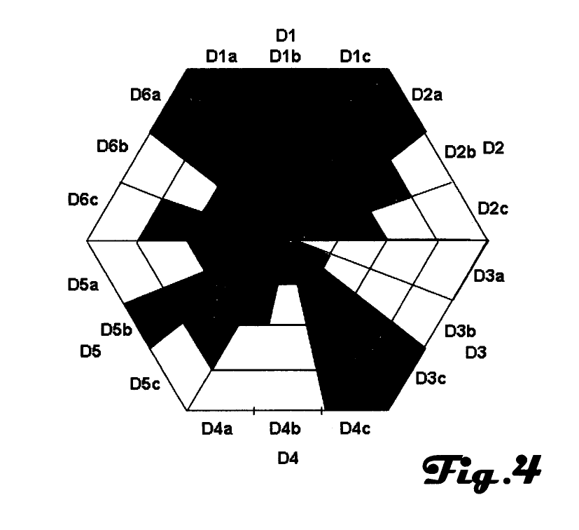

In various embodiments, the values associated with standardized categories and sub-categories are made accessible to a user using a graphing application to provide an individual seller's visual representation of results. In various embodiments, the results are presented with one or more visual indicators. FIG. 4 illustrates generally one embodiment of a individual seller's visual representation according to the subject matter disclosed herein. According to the embodiment of FIG. 4, the visual indicator is shading of a particular areas associated with one or more standardized categories or sub-categories. According to this embodiment, the more an area associated with a standardized category or sub-category is shaded, the higher the score the service provider received in value according to that category or sub-category. In other embodiments, the visual indicator is coloring of a particular area associated with a standardized category or sub-category.

In various alternative embodiments according to the subject matter disclosed herein, non-hexagonal shapes may be used to represent data. In various preferred embodiments, the shape has more than 4 sides (i.e. not a quadrilateral). In various preferred embodiments, the desirable shapes are the family of shapes which all sides are substantially equal and all angles are substantially equal, because each side may be divided into equal subsets. Example of preferred shapes included in this group are pentagon, hexagon, heptagon, octagon, enneagon, decagon, and the like, or any other shape with substantially equal sides.

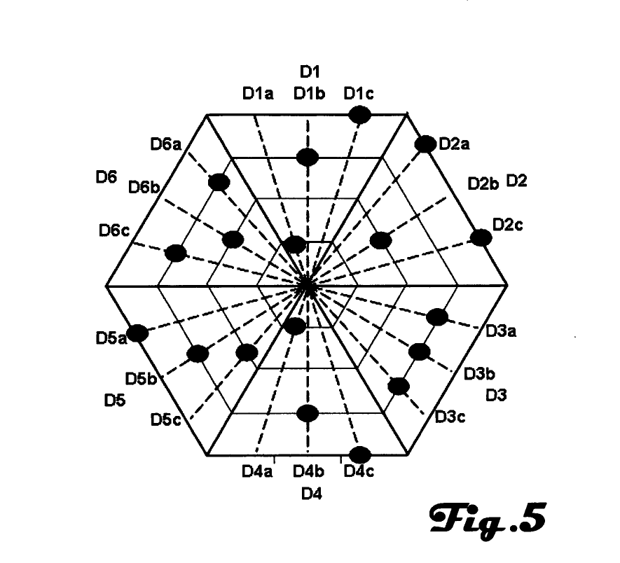

FIG. 5 illustrates generally an alternative embodiment of the seller specific visual representation. According to this embodiment, the visual indicator takes the form of a plot of the value wherein the location of the plot indicates the score of the seller for a category or sub-category.

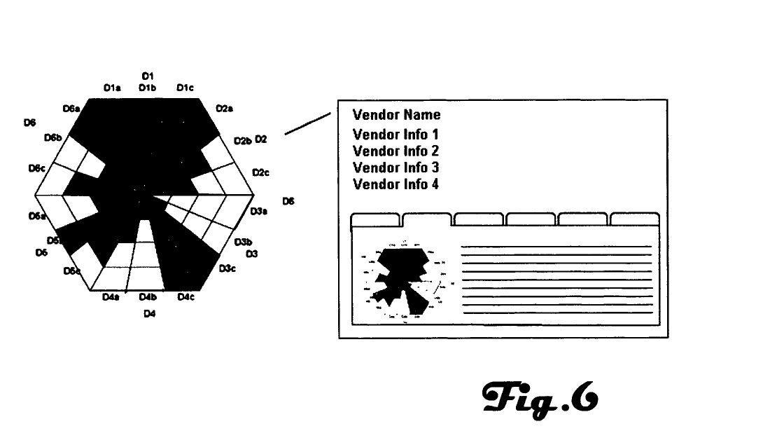

FIG. 6 illustrates generally one embodiment of a individual seller visual representation according the subject matter disclosed herein that is adapted to allow a user to drill down to determine additional information associated with a standardized category or a sub-category. According to this embodiment, the individual seller's visual representation includes a selectable window display. The selectable window display provides the user with a series of tabs corresponding to each of the standardized categories or sub-categories. These tabs display associated comments and calculations used in the individual seller's visual representation as well as the content and information that was used to determine values.

Having identified how to visually represent the capabilities of a seller, a buyer may be inclined to want a faster way of eliminating or selecting a series of sellers. In various embodiments, the values of the standardized category are compared to criteria to establish a general score for a particular seller. In one embodiment, this general score is presented using a conventional type scale such as the Bronze, Silver, Gold, Platinum labels common in many customer loyalty type programs.

The general score evaluation is conducted one seller at a time and may still prove too time consuming across the multitude of sellers. Therefore, in one embodiment, a buyer might be interested in using a mechanism to filter in or filter out those sellers that don't meet a series of criteria and then perform the analysis of individual sellers.

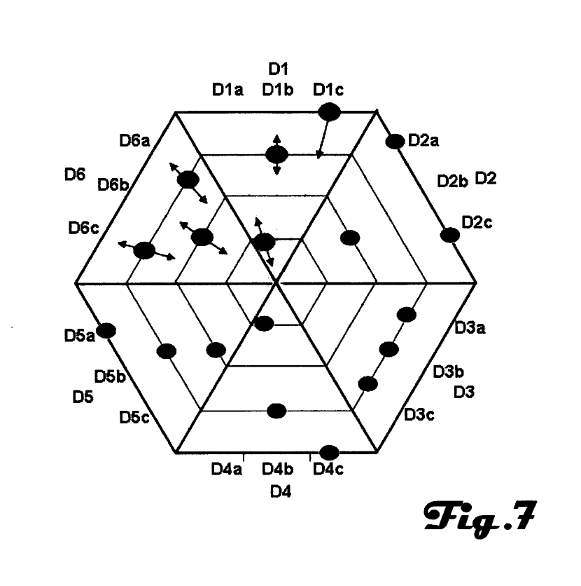

FIG. 7 illustrates generally one embodiment of a buyer preference visual representation that includes selectable slide bars. According to this embodiment, the system offers a buyer the ability to move a slide along each of the six axes according to the percentage of importance that each of the criteria means to them. In one embodiment, the closer to the centre is 0% and the percentage grows according to the level of importance to a maximum of 100% at the end of the axis.

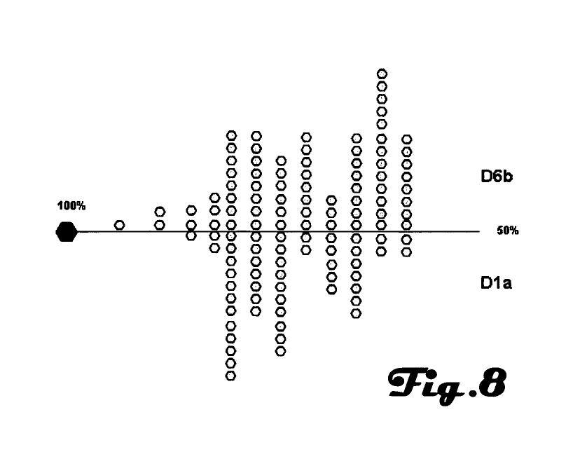

FIG. 8 illustrates generally one embodiment of aggregate seller visual representation according to the subject matter disclosed herein. According to this embodiment, a visual representation of a plurality of potential sellers is provided to a buyer based on the buyer's selection of the percentage of importance as discussed with respect to FIG. 7 above. By sliding the axis as a function of the importance of a specific metric, a calculation for each of the sellers that match the selected criteria is performed and the sellers are plotted on a result screen that places them on an axis from 100% (i.e. complete match) to a value of x % against the sum of all buyer values and displayed against the biggest two vectors selected by a customer.

As each axis is drawn, the aggregate seller visual representation result is filled (See FIG. 8). As each axis is determined, the resulting plot changes and the position of each seller changes as well. Therefore, a individual seller visual representation dynamically shifts according to the changes in the buyer preference visual representation values. The closer the seller's icon is to the buyer's 100% point, the more accurate is the comparison to that seller

In various embodiments, the following calculations may be used to determine the values used in the buyer preference visual representation:
The two D(x) on either side of the Plot results are determined as a function of the sum of all the subset values of each D(x) and the two highest D(x) scores becoming the two D(x) on either side of the axis.
The largest subset value for each of the two highest D(x) is selected as the representative value to plot a seller.
Sellers are first matched along the axis as a function of their total match to a sellers' total profile and then plotted according to their highest subset D(x) value from the two retained D(x) for that customer.
For example, assuming that a customer has made choices such as those described in the following table:

TABLE 1

| | | | |
|---|---|---|---|
| D1 | a | 85% | 232% |
| | b | 82% | |
| | c | 65% | |
| D2 | a | 78% | 211% |
| | b | 75% | |
| | c | 58% | |
| D3 | a | 71% | 190% |
| | b | 68% | |
| | c | 51% | |
| D4 | a | 64% | 169% |
| | b | 61% | |
| | c | 44% | |
| D5 | a | 57% | 148% |
| | b | 54% | |
| | c | 37% | |
| D6 | a | 73% | 237% |
| | b | 87% | |
| | c | 77% | |

The sum of all the subset D(x) values for D1 and D6 are the highest and will be selected on either side of the cumulative matching axis
Among these D(x), the subset values for D6(b) and D1(a) are the highest among these values and are therefore selected for the default rendering
A seller is then plotted along the axis in terms of matching characteristics and then positioned as a function of the seller's highest score between the D(x) subset values retained.
A buyer can obviously elect to select his own values to be represented on either side of the aggregate matching to the buyers D(x) criteria.

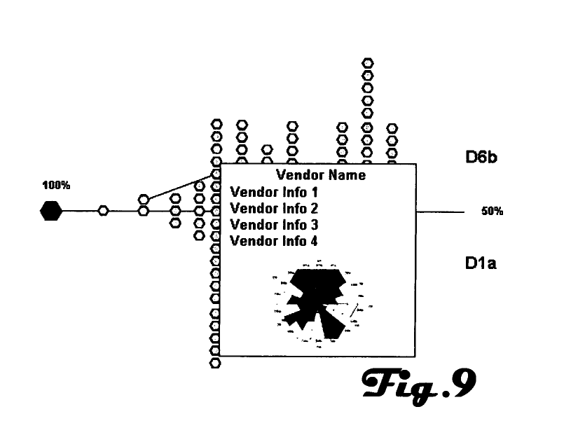

In one embodiment, a buyer is able to interact with the aggregate seller visual representation in order to select a particular seller. In one embodiment, selection of a particular seller results in presentation to the buyer of seller hexagon as illustrated in FIG. 9.

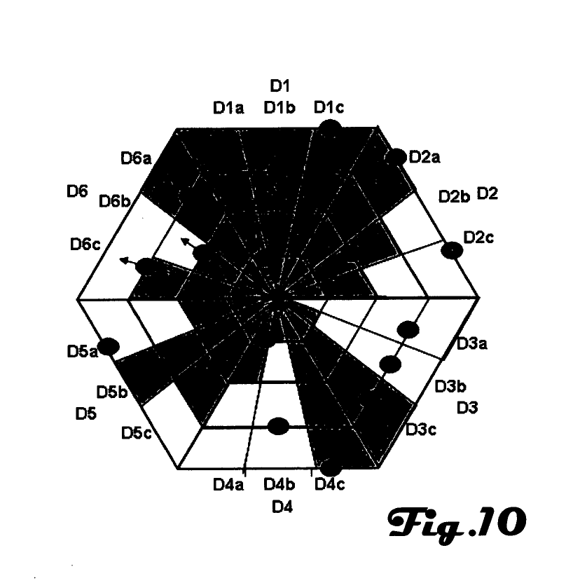

In various embodiments, when a buyer is satisfied with their selection criteria, the buyer is provided with an option to to click on the sellers name and the individual seller visual representation is provided as an overlay on the buyer's hexagon as illustrated in FIG. 10. In this way, the match between the Buyer's requirements and the Seller's provision can be easily seen.

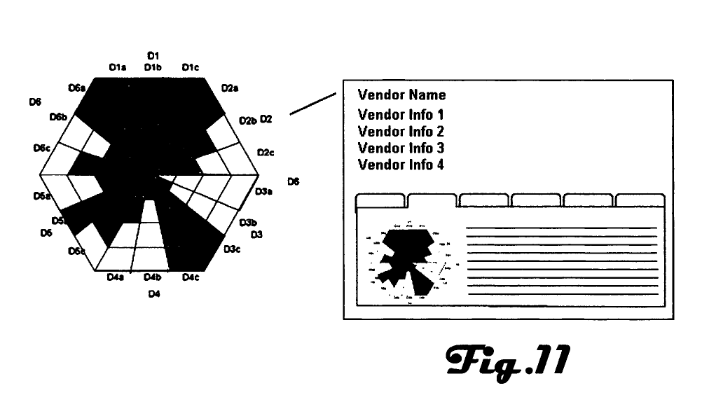

As described earlier with respect to FIG. 6, the individual seller visual representation may be drilled down further allowing for a complete view on each aspect of the assessment and see the subset evaluation for each element as depicted in FIG. 11.

Once the Buyer is ready to make a decision from this process, they are able to save the seller's name to a basket to investigate later the seller's details and go back and compare other sellers remaining on their aggregate seller visual representation using the same process.

In various embodiments, after a buyer is satisfied with the number of sellers added to their basket using the process described they are able to complete their request process by processing their basket through an RFI, RFP or RFQ.

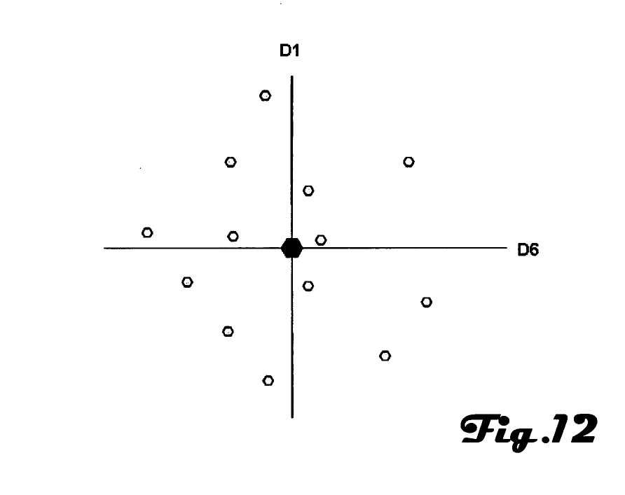

In an additional embodiment, a buyer is provided with a two-category diagram such as the one depicted in FIG. 12 to more easily identify the scoring and evaluation measures of sellers that are most relevant to that customer's requirements.

In this instance, a buyer selects two categories of interest and the sellers are plotted against these two categories with 100% match being in the center of the axis, hence sellers with a 100% match to the criteria of buyers would be an overlay on the center of the axis. In this instance the display for seller is represented by the conventional Bronze to Platinum leveling to further help a buyer have an understanding of the types of buyers represented.

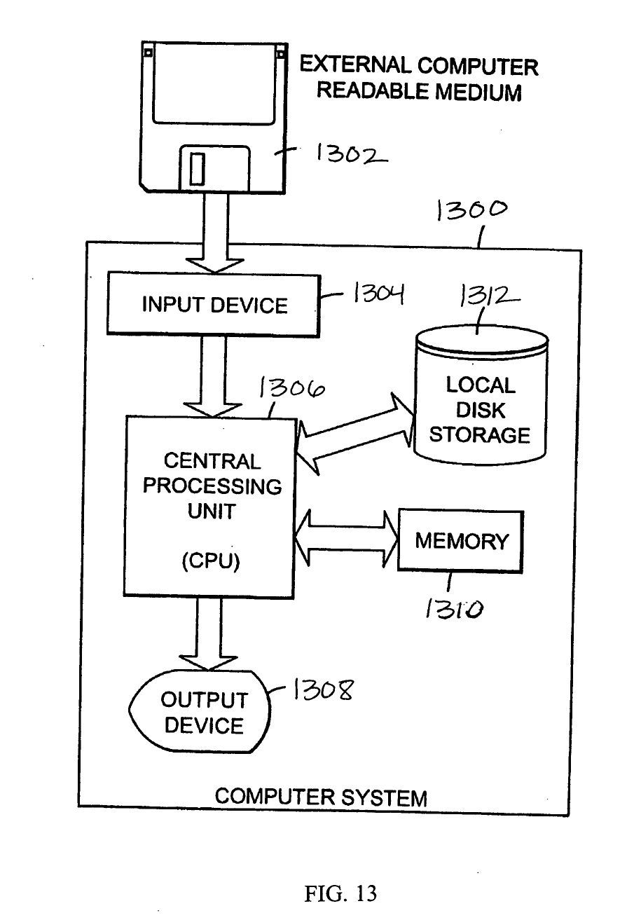

Aspects of the present invention can be realized in a number of embodiments, including one or more realizations in hardware, in software/firmware, and in a combination of hardware and software/firmware. When realized in software or firmware, the present invention can include several main components which are each a software program. The main software program components run on one or more computer systems. In one embodiment, each of the main software program components runs on its own computer system. FIG. 13 illustrates one embodiment of a computer system 1300 and an external computer readable medium 1302 which can be employed according to the present invention to implement one or more of the main software program according to the present invention. Embodiments of external computer readable medium 1302 include, but are not limited to: a nonvolatile memory, a CD-ROM, a floppy disk, and a disk cartridge. Any one of the main software program components according to the present invention can be implemented in a variety of compiled and interpreted computer languages. External computer readable medium 1302 stores source code, object code, executable code, shell scripts and/or dynamic link libraries for any one of the main software program components according to the present invention. An input device 1304 reads external computer readable medium 1302 and provides this data to computer system 1300. Embodiments of input device 1304 include but are not limited to: a USB port, a CD-ROM reader, a floppy disk drive, and a data cartridge reader.

Computer system 1300 includes a central processing unit 1306 for executing any one of the main software program components according to the present invention. Computer system 1300 also includes local disk storage 1312, which is a computer readable medium for locally storing any one of the main software program components according to the present invention before, during, and after execution. Any one of the main software program components according to the present invention also utilizes memory 1310, which is a computer readable medium within the computer system, during execution. Upon execution of any one of the main software program components according to the present invention, output data is produced and directed to an output device 1308. Embodiments of output device 1308 include, but are not limited to: a computer display device, a printer, and/or a disk storage device.

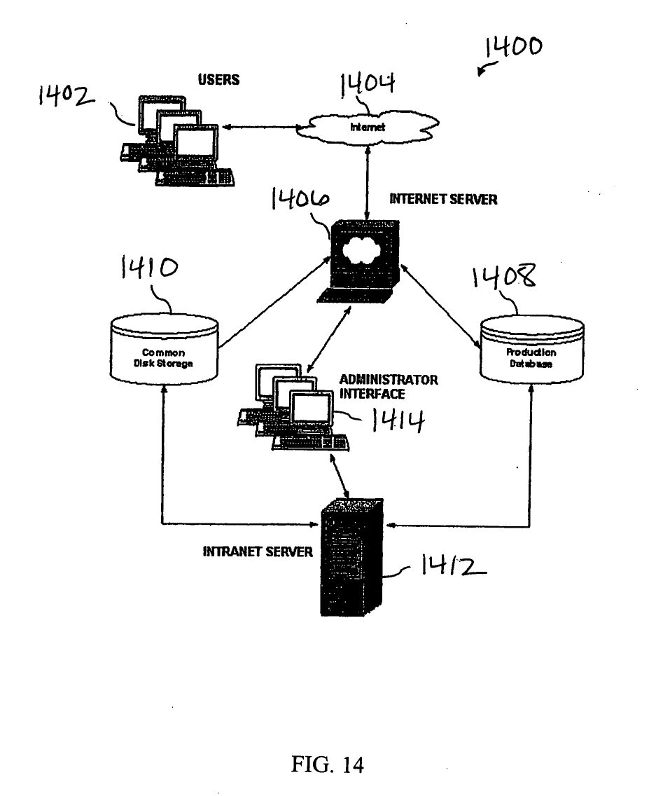

FIG. 14 illustrates an example of a computer network system in which the present invention can be implemented. Users of the present invention can utilize any suitable computer having access to internet 1404 via web browser software. Internet server 1406 manages communications sessions each user 1402. Also, internet server 1402 executes any software associated with the present invention. In one embodiment, the data relating to the present invention is stored in and accessed from production data base 1408. Common disc storage 1410 stores application program instructions, and related data associated with the present invention.

To facilitate system development, maintenance, and customer service, an intranet server 1412 is interfaced with production database 1408 and 1410. For development, off-line applications associated with the present invention can be run on intranet server 1412. A maintenance application can run on intranet server 1412. Intranet server 1412 can also interface with or execute at least a portion of the applications associated with the instant invention while permitting a customer service provider to help users complete their transactions.

Administrator interface 1414 can communicate selectively with internet server 1406 or intranet server 1412 to permit the uniform provider to monitor, maintain, reconfigure, or use system 1400.

In a related embodiment, system 1400 can also run related applications. Processing of these applications can take place, as appropriate, at internet server 1406 or intranet server 1412.

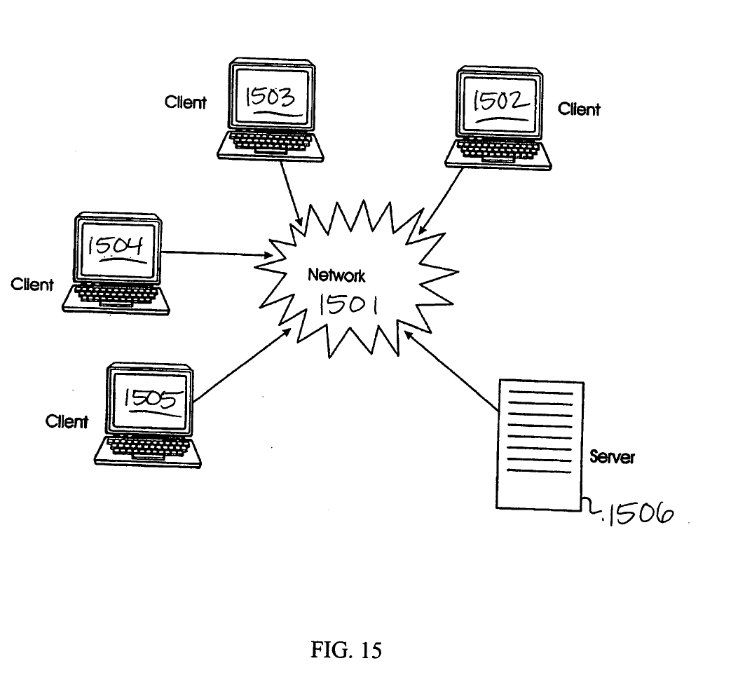

FIG. 15 illustrates generally a client-server network on which the present invention might be practiced. It consists of a server 1506 connected to a network 1501. The network could be any type of network like Local Area Network, Internet and the like. Also present on the network are different clients 1501, 1502, 1503, 1504, and 1505. The interconnection between different clients on the network could be by any known communication means such as wired means, radio links or by infrared transmissions. The networking topology could be any known topology such as star, linear, ring and the like or a combination of any of these. The clients and the server could use any of the known communication protocols such as TCP/IP, Ethernet and the like for communication. The number of servers and the clients is not limited and the data could reside either on one server or could be distributed over a number of servers. The server 1506 acts as the service provider and clients send requests to the server for availing the services provided by it. The clients might themselves be the customers 1502 and 1503 or two or more clients might belong to one customer 1504 and 1505. The enforcement of SLA is required between the service provider i.e. the server 1506 and each customer.

The clients 1502, 1503, 1504, and 1505 could be electronic devices like personal computers, mobile phones, interactive televisions and the like, being operated by humans or they could be software agents running on electronic devices on behalf of individuals or organizations.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A computer-based system for presenting multi-category scoring of a provider of goods or services substantially as shown and described herein, and its equivalents.

2. A computer-based method for presenting multi-category scoring of a provider of goods or services substantially as shown and described herein, and its equivalents.
